(19) United States
(12) Patent Application Publication
(10) Pub. No.: US 2025/0341657 A1
(43) Pub. Date: Nov. 6, 2025

(54) OPTICAL LENS

(71) Applicant: Panasonic Intellectual Property Management Co., Ltd., Osaka (JP)

(72) Inventors: KEIGO MASUDA, Osaka (JP); EIJI TAKEDA, Osaka (JP)

(21) Appl. No.: 19/269,104

(22) Filed: Jul. 15, 2025

Related U.S. Application Data
(63) Continuation of application No. PCT/JP2023/046841, filed on Dec. 27, 2023.

(30) Foreign Application Priority Data
Jan. 31, 2023 (JP) 2023-013485

(51) Int. Cl. G02B 3/10; G02B 1/00

(52) U.S. Cl. CPC G02B 3/10; G02B 1/002

(57) ABSTRACT

An optical lens that is used for light having a wavelength within a predetermined target wavelength range includes a substrate having a surface and a plurality of microstructural bodies two-dimensionally provided at the surface of the substrate. The plurality of microstructural bodies include, on the surface of the substrate, a first area and a second area located outside the first area. The first area has a property of condensing, at a predetermined focal length, first incident light incident on the first area. The second area has at least one selected from the group consisting of (a) a property of refracting inward second incident light incident on the second area, (b) a property of diffusing the second incident light, (c) a property of reflecting the second incident light, and (d) a property of absorbing the second incident light.

### BACKGROUND

### 1. Technical Field

The present disclosure relates to an optical lens.

### 2. Description of the Related Art

In recent years, a meta-lens having a microscopic surface structure called “meta-surface” has been under study and development. A meta-surface is a surface having a meta-material structure that achieves an optical function that does not occur in nature. A meta-lens can achieve, with one thin flat-plate structure, an optical function that is comparable to that of a combination of a plurality of conventional optical lenses. For this reason, a meta-lens can contribute to reductions in size and weight of lens-equipped devices such as cameras, LiDAR sensors, projectors, and AR (augmented reality) displays. Examples of a meta-lens and a device including a meta-lens are disclosed, for example, in Japanese Unexamined Patent Application Publication (Translation of PCT Application) No. 2019-516128 and Japanese Unexamined Patent Application Publication No. 2021-71727.

Japanese Unexamined Patent Application Publication (Translation of PCT Application) No. 2019-516128 discloses a meta-lens including a substrate and a plurality of nanostructural bodies placed on top of the substrate. In this meta-lens, the plurality of nanostructural bodies bring about optical phase shifts that vary depending on their positions, and the optical phase shifts brought about separately by each nanostructural body define a phase profile of the meta-lens. The optical phase shift of each nanostructural body depends on the position of the nanostructural body and the size or orientation of the nanostructural body. Examples of nanostructural bodies include nanofins and nanopillars. Japanese Unexamined Patent Application Publication (Translation of PCT Application) No. 2019-516128 states that a desired phase shift is achieved by adjusting the angle of placement of each nanofin or adjusting the size of each nanopillar.

Japanese Unexamined Patent Application Publication No. 2021-71727 discloses a miniaturized lens assembly including a meta-lens and an electronic device including the same. The meta-lens disclosed in Japanese Unexamined Patent Application Publication No. 2021-71727 includes a nanostructural array and is configured to form an identical phase delay profile for light of at least two different wavelengths included in incident light. In order to achieve a desired phase delay profile, this meta-lens is configured such that the width of each of a plurality of inner columns included in the nanostructural array is appropriately determined according to the required amount of phase delay.

### SUMMARY

In one general aspect, the techniques disclosed here feature an optical lens that is used for light having a wavelength within a predetermined target wavelength range. The optical lens includes a substrate having a surface and a plurality of microstructural bodies two-dimensionally provided at the surface of the substrate. The plurality of microstructural bodies include, on the surface of the substrate, a first area and a second area located outside the first area. The first area has a property of condensing, at a predetermined focal length, first incident light incident on the first area. The second area has at least one selected from the group consisting of (a) a property of refracting inward second incident light incident on the second area, (b) a property of diffusing the second incident light, (c) a property of reflecting the second incident light, and (d) a property of absorbing the second incident light.

It should be noted that general or specific embodiments may be implemented as a system, an apparatus, a method, an integrated circuit, a computer program, a storage medium, or any selective combination thereof. The computer-readable storage medium can include a volatile storage medium or can include a nonvolatile storage medium such as a CD-ROM (compact disc read-only memory). The apparatus may be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing an example of a meta-lens;

FIG. 2 is a perspective view schematically showing an example of a structure of one unit cell;

FIG. 3 is a diagram schematically showing a function of the meta-lens;

FIG. 4 is a ray trace diagram schematically showing a case where light falls on the conventional meta-lens;

FIG. 5 is a diagram schematically showing a configuration of a meta-lens according to an exemplary embodiment of the present disclosure;

FIG. 6A is a ray trace diagram schematically showing a case where light falls on a first meta-lens serving as an example of the meta-lens according to the present embodiment;

FIG. 6B is a ray trace diagram schematically showing a case where light falls on a second meta-lens serving as an example of the meta-lens according to the present embodiment;

FIG. 6C is a ray trace diagram schematically showing a case where light falls on a third meta-lens serving as an example of the meta-lens according to the present embodiment;

FIG. 6D is a ray trace diagram schematically showing a case where light falls on a fourth meta-lens serving as an example of the meta-lens according to the present embodiment;

FIG. 7 is a diagram for explaining a method for determining a spacing between microstructural bodies in a first area;

FIG. 8A is a diagram schematically showing an example of an ideal phase profile in an unwrapped state;

FIG. 8B is a diagram schematically showing an ideal phase profile wrapped in a range of phases of −π to π;

FIG. 8C is a diagram schematically showing an example of sampling for achieving an ideal phase profile;

FIG. 9A is a diagram schematically showing an example of a phase profile of the first meta-lens in an unwrapped state;

FIG. 9B is a diagram for explaining conditions that a first focal length and a second focal length satisfy in the first meta-lens;

FIG. 10A is a diagram schematically showing an example of a phase profile of the second meta-lens in an unwrapped state;

FIG. 10B is a diagram for explaining conditions that a first focal length and a second focal length satisfy in the second meta-lens;

FIG. 11A is a diagram schematically showing an example of positional dependence of reflectance in the third meta-lens;

FIG. 11B is a diagram schematically showing an example of positional dependence of transmittance in the third meta-lens;

FIG. 12 is a diagram schematically showing an example of positional dependence of absorptance in the fourth meta-lens;

FIG. 13A is a diagram schematically showing a structure of a substrate and each of the microstructural bodies in an example of the first meta-lens;

FIG. 13B is a graph showing a relationship between the diameters of the microstructural bodies and phase shift amount and a relationship between the diameters of the microstructural bodies and transmittance in the example of the first meta-lens;

FIG. 13C is a graph showing a phase profile of the example of the first meta-lens in an unwrapped state;

FIG. 13D is a graph showing a relationship between coordinates and the diameters of the microstructural bodies in the example of the first meta-lens;

FIG. 13E is a ray trace diagram of a case where light falls perpendicularly on the example of the first meta-lens;

FIG. 14A is a graph showing a phase profile of an example of the second meta-lens in an unwrapped state;

FIG. 14B is a graph showing a relationship between coordinates and the diameters of the microstructural bodies in the example of the second meta-lens;

FIG. 14C is a ray trace diagram of a case where light falls perpendicularly on the example of the second meta-lens;

FIG. 15A is a graph showing a relationship between the diameters of the microstructural bodies and phase shift amount and a relationship between the diameters of the microstructural bodies and transmittance in an example of the third meta-lens;

FIG. 15B is a graph showing a relationship between coordinates and the diameters of microstructural bodies in the example of the third meta-lens;

FIG. 15C is a graph showing a relationship between coordinates and transmittance, a relationship between coordinates and reflectance, and a relationship between coordinates and absorptance in a case where light falls perpendicularly on the example of the third meta-lens;

FIG. 16A is a perspective view schematically showing a structure of a second area in an example of the fourth meta-lens as seen from the substrate;

FIG. 16B is a graph showing a relationship between coordinates and transmittance, a relationship between coordinates and reflectance, and a relationship between coordinates and absorptance in a case where light falls perpendicularly on the example of the fourth meta-lens;

FIG. 17A is a cross-sectional view schematically showing an example of a meta-lens including a light modulation layer; and

FIG. 17B is a cross-sectional view schematically showing an example of a meta-lens in which a light modulation layer includes a plurality of other microstructural bodies that are different from the microstructural bodies.

### DETAILED DESCRIPTIONS

In order to achieve a desired lens function, a conventional meta-lens is configured such that a plurality of microstructures are placed in a circular pattern at a surface of a substrate having a polygonal shape such as a regular square. The plurality of microstructural bodies are not placed in a peripheral area on the surface of the substrate. The peripheral area, which does not have a desired lens property, may cause deterioration in performance of the meta-lens.

One non-limiting and exemplary embodiment provides an optical lens that makes it possible to reduce deterioration of performance even if there is an area that does not have a desired lens function.

The following describes an exemplary embodiment of the present disclosure. It should be noted that the embodiments to be described below each illustrate a comprehensive and specific example. The numerical values, shapes, constituent elements, placement and topology of constituent elements, steps, orders of steps, or other features that are shown in the following embodiments are just a few examples and are not intended to limit the technology of the present disclosure. Further, those of the constituent elements in the following embodiments which are not recited in an independent claim reciting the most superordinate concept are described as optional constituent elements. Further, the drawings are schematic views and are not necessarily strict illustrations. Further, in the drawings, identical or similar constituent elements are given identical reference signs. A repeated description may be omitted or simplified.

The term “light” herein refers to not only visible light (with wavelengths of approximately 400 nm to approximately 700 nm) but also invisible light. The term “invisible light” means electromagnetic waves included in wavelength ranges of ultraviolet radiation (with wavelengths of approximately 10 nm to approximately 400 nm), infrared radiation (with wavelengths of approximately 700 nm to approximately 1 mm), or radio waves (with wavelengths of approximately 1 mm to approximately 1 m). An optical lens in the present disclosure can be used for not only visible light but also invisible light such as ultraviolet radiation, infrared radiation, or radio waves.

### Underlying Knowledge Forming Basis of the Present Disclosure

First, an example of a basic configuration of an optical lens in the present disclosure and the inventors' findings are described.

In the following description, the optical lens is also referred to as “meta-lens”. The meta-lens is an optical element having at a surface thereof a plurality of microstructural bodies that are smaller than wavelengths of incident light, and those microstructural bodies bring about phase shifts by which a lens function is achieved. It is possible to adjust the optical properties such as phase, amplitude, or polarization of incident light by appropriately designing the shape, size, orientation, and placement of each microstructural body.

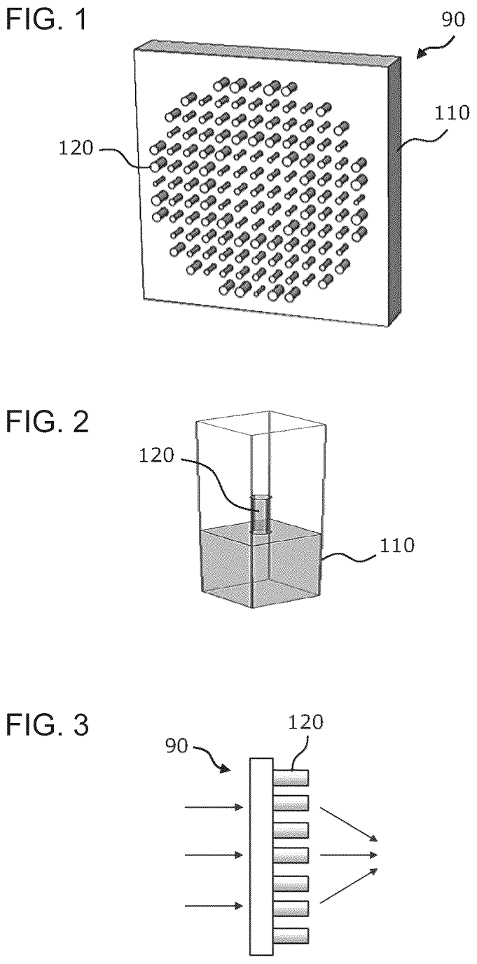

FIG. 1 is a perspective view schematically showing an example of a conventional meta-lens. A meta-lens 90 shown in FIG. 1 includes a substrate 110 and a plurality of microstructural bodies 120 provided at a surface of the substrate 110. Each microstructural body 120 in this example is a columnar body, also called “pillar”, that is similar in shape to a circular cylinder. A unit element including one microstructural body 120 in the meta-lens 90 is referred to as “unit cell”. The meta-lens 90 is an aggregate of a plurality of unit cells.

FIG. 2 is a perspective view schematically showing an example of a structure of one unit cell. One unit cell includes part of the substrate 110 and one microstructural body 120 projecting from the part of the substrate 110. Each unit cell causes incident light to undergo a phase shift according to a structure of the microstructural body 120.

FIG. 3 is a diagram schematically showing a function of the meta-lens 90. In FIG. 3, the arrows indicate examples of rays. In this example, the meta-lens 90 has a property of condensing incident light as is the case with a conventional convex lens. In the example shown in FIG. 3, incident light falling on the substrate 110 of the meta-lens 90 is subjected by the array of microstructural bodies 120 to phase variations differing according to position, and is condensed. The shape, width, height, orientation, or other attributes of each microstructural body 120 are appropriately determined so that the desired light-condensing property is achieved. The structure of each microstructural body 120 can be appropriately determined, for example, based on data representing the phase profile to be achieved and a result of an electromagnetic field simulation.

The microstructural bodies 120 each has a subwavelength size (e.g. width and height) shorter than the wavelength of incident light falling on the meta-lens 90 and can be placed at subwavelength spacings or pitches. A “spacing” between microstructural bodies 120 is the center-to-center distance between two microstructural bodies 120 that are adjacent to each other when seen from a direction perpendicular to the surface of the substrate 110.

The meta-lens 90 can be designed to achieve a desired optical property for light having a wavelength within a predetermined target wavelength range. The target wavelength range is, for example, a wavelength range defined according to specification. In a case where a lower limit of the target wavelength range is, for example, 1 μm, the size of the microstructural body 120 and the spacing between the microstructural bodies 120 can be set to a value shorter than 1 μm. Such a microstructural body of nanoscale size smaller than 1 μm is sometimes called “submicron structural body” or “nanostructural body”. In a case where the target wavelength range is an infrared wavelength range, the size of the microstructural body 120 and the spacing between the microstructural bodies 120 may be greater than 1 μm.

The number of microstructural bodies 120 that are provided at a surface of the meta-lens 90 is appropriately determined according to the lens function to be achieved. The number of microstructural bodies 120 falls within a range of, for example, 100 to 10,000 and, in some case, may be smaller than 100 or larger than 10,000.

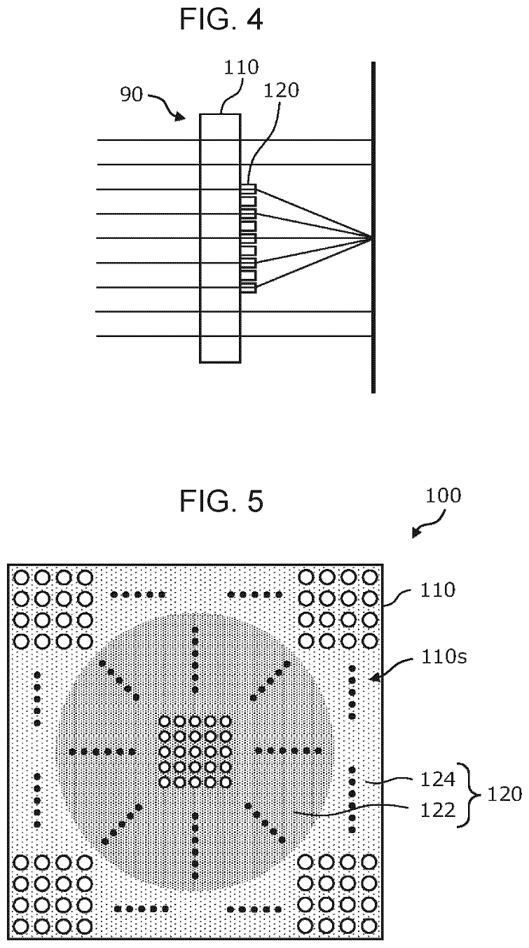

A problem that can arise in the conventional meta-lens 90 is described here with reference to FIG. 4. FIG. 4 is a ray trace diagram schematically showing a case where light falls on the conventional meta-lens 90. In FIG. 4, the solid lines represent rays falling on the conventional meta-lens 90. As shown in FIG. 1, the meta-lens 90 has a circular area in which the plurality of microstructural bodies 120 are placed in a circular pattern and a peripheral area in which the plurality of microstructural bodies 120 are not placed. The circular area has a desired lens function.

As shown in FIG. 4, light falling on the circular area is condensed onto a planar image surface represented by a heavy line. On the other hand, light falling on the peripheral area travels straight and falls on the image surface. Accordingly, in a case where an image sensor takes an image of the incident light via the meta-lens 90 in a state in which an imaging surface of the image sensor is included in the aforementioned image surface, not only the light condensed by the circular area but also excess light traveling straight through the peripheral area fall on the imaging surface of the image sensor. This excess light reduces the accuracy of imaging. In this way, the peripheral area, which does not have the desired lens function, of the meta-lens 90 may cause deterioration in performance of the meta-lens 90.

The inventors found that in a case where a meta-lens has an area that does not have a desired lens function, the area may undesirably cause deterioration in performance of the meta-lens, and conceived of an optical lens according to an embodiment of the present disclosure to solve this problem. The following describes a configuration of an optical lens according to an embodiment of the present disclosure. The structure of each microstructural body 120 in the aforementioned conventional meta-lens 90 and the method for designing the same can also be applied to an optical lens according to an embodiment of the present disclosure.

### Embodiment

In one general aspect, the techniques disclosed here feature an optical lens that is used for light having a wavelength within a predetermined target wavelength range. The optical lens includes a substrate having a surface and a plurality of microstructural bodies two-dimensionally provided at the surface of the substrate. The plurality of microstructural bodies include, on the surface of the substrate, a first area and a second area located outside the first area. The first area has a property of condensing, at a predetermined focal length, first incident light falling on the first area. The second area has at least one selected from the group consisting of (a) a property of refracting inward second incident light falling on the second area, (b) a property of diffusing the second incident light, (c) a property of reflecting the second incident light, and (d) a property of absorbing the second incident light.

The “target wavelength range” here is a wavelength range of light for which the optical lens is supposed to be used, and can be determined based on the specifications of the optical lens or the specifications of a device mounted with the optical lens. The target wavelength range may include, for example, at least part of a wavelength range of visible light (from approximately 400 nm to approximately 700 nm). Alternatively, the target wavelength range may include, for example, at least part of a wavelength range of ultraviolet radiation (from approximately 10 nm to approximately 400 nm). Alternatively, the target wavelength range may include, for example, at least part of a wavelength range of infrared radiation (from approximately 700 nm to approximately 1 mm). Alternatively, the target wavelength range may include, for example, at least part of a wavelength range of radio waves (from approximately 1 mm to approximately 1 m). In an example, the target wavelength range can include at least part of a wavelength range of infrared radiation of 2.5 μm to 25 μm. The wavelength range of 2.5 μm to 25 μm can be suitably utilized for an infrared sensing device such as a LiDAR sensor or an infrared camera. The term “wavelength” herein means a wavelength in free space unless otherwise noted.

The substrate and each microstructural body can be made of a material having translucency with respect to light having a wavelength within the target wavelength range. The phrase “having translucency” here means having a property of transmitting incident light at a transmittance higher than 50%. In an embodiment, the substrate 110 and each microstructural body 120 may be made of a material that transmits, at a transmittance of 80% or higher, light having a wavelength within the target wavelength range.

A “spacing” between microstructural bodies means the center-to-center distance between two microstructural bodies that are adjacent to each other when seen from a direction perpendicular to the surface (hereinafter also referred to as “lens surface”) of the substrate. In a case where a shortest wavelength in the target wavelength range is, for example, 2.5 μm, the center-to-center distance between two of the plurality of microstructural bodies that are adjacent to each other is shorter than 2.5 μm. Since the width of a microstructural body is smaller than the spacing between microstructural bodies, the width of a microstructural body is shorter than a shortest wavelength in the target wavelength range.

The spacing between the microstructural bodies 120 is determined according to a phase profile that the optical lens should achieve. The phase profile represents a distribution within a lens surface of the shift amount of phase (hereinafter sometimes referred to simply as “phase”) of emitted light with respect to the phase of incident light falling on the optical lens. The phase profile can be expressed, for example, by a function of phase with respect to position within the lens surface or distance from an optical axis. The phase profile indicates different phases according to position within the lens surface. In the present embodiment, the spacing between microstructural bodies is determined according to the phase profile to be achieved so as to differ according to position on the lens surface (e.g. distance from the optical axis).

The following describes, with reference to FIG. 5, an example configuration of a meta-lens according to an embodiment of the present disclosure. The meta-lens according to the embodiment of the present disclosure can be used in combination with an image sensor, for example, in an imaging device. The meta-lens can also be used in a telescope, a microscope, or an optical scanner. Note, however, that the meta-lens is not limited to these uses.

FIG. 5 is a diagram schematically showing a configuration of a meta-lens according to an exemplary embodiment of the present disclosure. A meta-lens 100 shown in FIG. 5 includes a substrate 110 having a surface 110s and a plurality of microstructural bodies 120 two-dimensionally provided at the surface 110s of the substrate 110. The plurality of microstructural bodies 120 may be provided in direct contact with the surface 110s of the substrate 110 or may be provided in indirect contact with the surface 110s of the substrate 110 via another member. Alternatively, the plurality of microstructural bodies 120 may be provided at spacings at the surface 110s of the substrate 110, for example, by using spacers.

As shown in FIG. 5, the plurality of microstructural bodies 120 include, on the surface 110s of the substrate 110, a first area 122 and a second area 124 located outside the first area 122. In FIG. 5, the first area 122 is represented by a dark hatched area, and the second area 124 is represented by a light hatched area.

In the example shown in FIG. 5, the substrate 110 has the shape of a regular square. The first area 122 is a circular area, and the second area 124 is a peripheral area surrounding the circular area. The center of the first area 122 coincides with the center of the surface 110s of the substrate 110. An end of the first area 122 coincides with an inner end of the second area 124. The shape of the substrate 110 does not need to be a regular square but may be any shape such as a polygon. The shape of the first area 122 does not need to be a circle but may be any shape such as a regular square. The second area 124 does not need to surround the first area 122.

For the sake of ease, FIG. 5 schematically shows, as part of the first area 122, a plurality of microstructural bodies 120 located near the center of the first area 122. Similarly, FIG. 5 schematically shows, as part of the second area 124, a plurality of microstructural bodies 120 located in four corners of the second area 124.

The first area 122 and the second area 124 differ from each other in at least one selected from the group consisting of a material of, a shape of, a size of, and a spacing between the plurality of microstructural bodies 120. Accordingly, the second area 124 differs in property from the first area 122.

The first area 122 has a property of condensing incident light at a predetermined focal length. In other words, the first area 122 functions as a convex lens having the predetermined focal length. The predetermined focal length is also referred to as “first focal length”. The first focal length has a positive value.

The second area 124 has at least one selected from the group consisting of (a) a property of refracting incident light inward, (b) a property of refracting the incident light outward, i.e. diffusing the incident light, (c) a property of reflecting the incident light, and (d) a property of absorbing the incident light. The second area 124 may have any of the properties (a) to (d). Alternatively, the second area 124 may be divided into two or more or four or less subareas each of which has a different property selected from among the properties (a) to (d).

The phrase “refracting incident light inward” herein means refracting the incident light so that the incident light travels toward the first area 122. The phrase “refracting incident light outward” herein means refracting the incident light so that the incident light travels away from the first area 122.

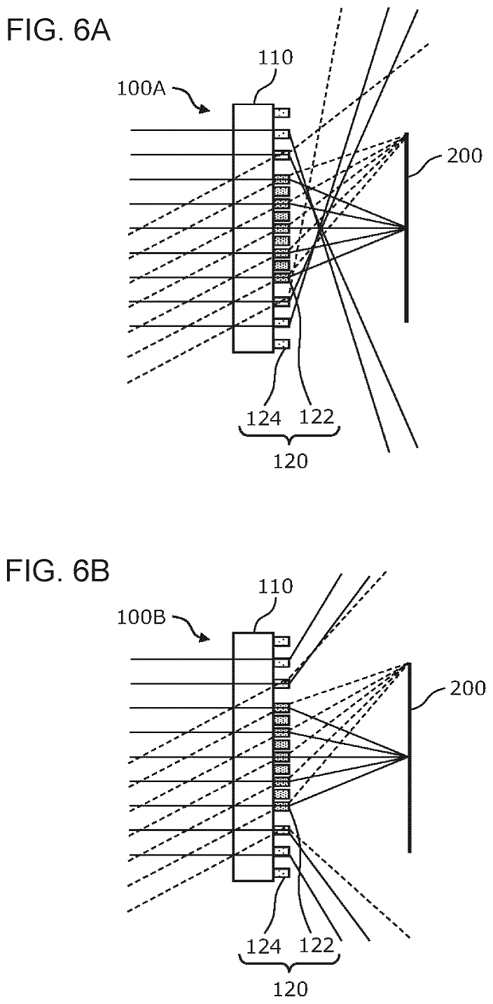

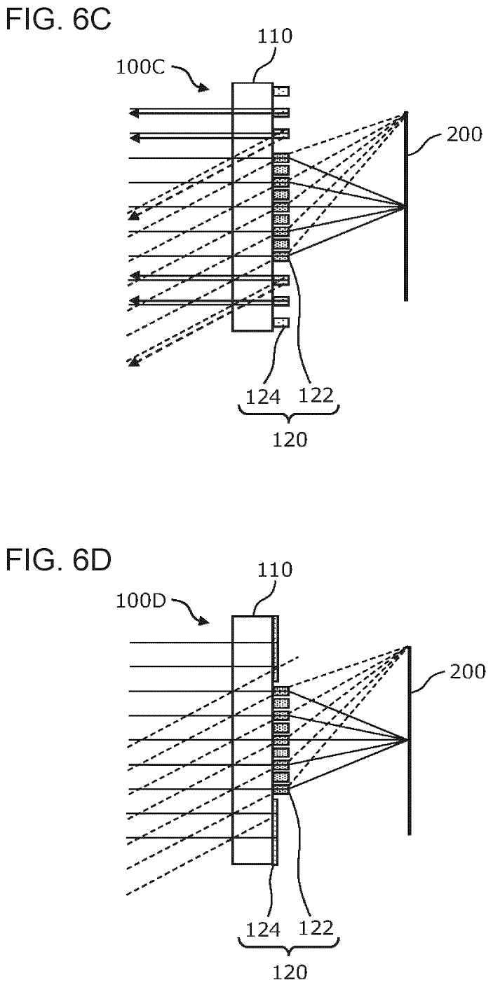

FIG. 6A to 6D are ray trace diagrams schematically showing cases where light falls on meta-lenses 100A to 100D serving as examples of the meta-lens 100 according to the present embodiment. The first meta-lens 100A, the second meta-lens 100B, the third meta-lens 100C, and the fourth meta-lens 100D are collectively referred to as “meta-lenses 100A to 100D”.

In each of FIGS. 6A to 6D, the solid lines represent rays falling perpendicularly on the first area 122 and the second area 124, and the dashed lines represent rays falling obliquely on the first area 122 at a maximum half angle of view. A maximum angle of incidence can be, for example, a maximum viewing angle of a device such as an imaging device, a telescope, or a microscope including the meta-lens 100 or a maximum scanning angle of an optical scanner including the meta-lens 100. An imaging area 200 shown in each of FIGS. 6A to 6D is an area in a planar image surface at the first focal length and represents an area onto which light falling on the first area 122 in an angular range of 0 degree to the maximum half angle of view is condensed. The imaging surface of the image sensor may include all of the imaging area 200.

The first areas 122 of the meta-lenses 100A to 100D have the same property of condensing incident light at the first focal length. The second areas 124 of the meta-lenses 100A to 100D have different properties as will be described below.

In the first meta-lens 100A, as shown in FIG. 6A, the second area 124 has the property (a) of refracting incident light inward. As a result of that, light falling on the second area 124 passes outside the imaging area 200 and therefore hardly arrives at the imaging area 200.

In the second meta-lens 100B, as shown in FIG. 6B, the second area 124 has the property (b) of diffusing the incident light. As a result of that, light falling on the second area 124 passes outside the imaging area 200 and therefore hardly arrives at the imaging area 200.

In the third meta-lens 100C, as shown in FIG. 6C, the second area 124 has the property (c) of reflecting the incident light. As a result of that, light falling on the second area 124 is reflected and therefore hardly arrives at the imaging area 200.

In the fourth meta-lens 100D, as shown in FIG. 6D, the second area 124 has the property (d) of absorbing the incident light. As a result of that, light falling on the second area 124 is absorbed and therefore hardly arrives at the imaging area 200.

As noted above, in each of the meta-lenses 100A to 100D, even if light falls on the second area 124, the light hardly arrives at the imaging area 200, as the second area 124 does not have a desired lens function. Accordingly, the present embodiment makes it possible to achieve a meta-lens 100 that makes it possible to reduce deterioration of performance even if there is a second area 124 that does not have a desired lens function. The meta-lens 100 according to the present embodiment makes it possible to, without using a separate cover or filter, reduce the possibility that excess light falling on the second area 124 may fall on the imaging area 200.

The following describes a method for designing the first area 122 first and then describes a detailed configuration of each of the meta-lenses 100A to 100D.

### Method for Designing First Area 122

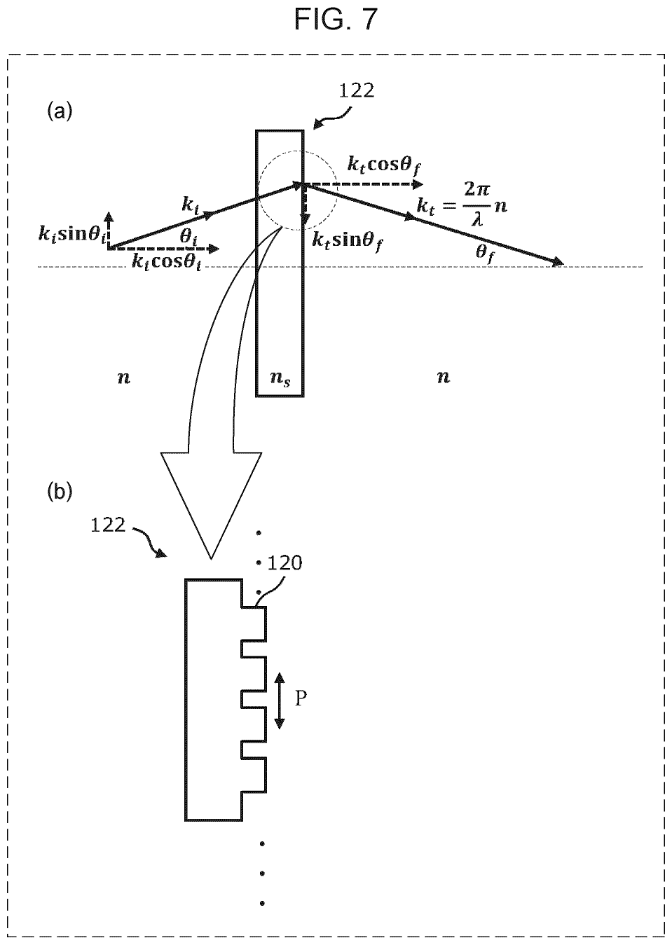

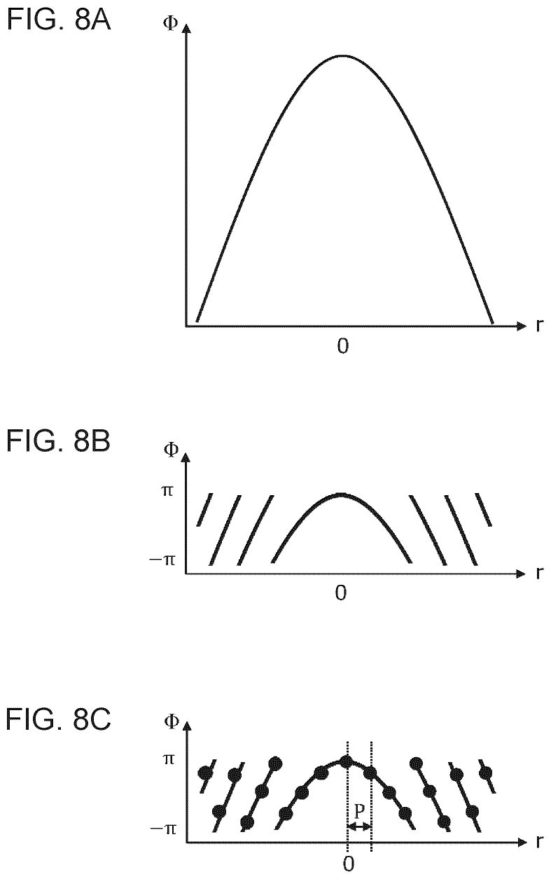

The following describes, with reference to FIG. 7, a method for designing the first area 122 so that first area 122 condenses not only perpendicularly incident light but also obliquely incident light onto the imaging area 200. The following design method may be applied to the second area 124.

FIG. 7 is a diagram for explaining a method for determining a spacing, i.e. a pitch P, between microstructural bodies 120 in a first area 122. Portion (a) of FIG. 7 schematically shows how light falling obliquely on the meta-lens 100 changes its course at a lens surface at which microstructural bodies 120 are formed. Portion (b) of FIG. 7 is a schematic enlarged view of an area surrounded by a dashed circle in portion (a).

In the example shown in FIG. 7, light of a wavelength kᵢ from a medium (e.g. air) of a refractive index n falls on a first area 122 of a refractive index nₛ at an angle of incidence θᵢ. Let it be assumed that kₜ (=2π·n/λ) is a wave number corresponding to the shortest wavelength λ in the target wavelength range and that NA=nsinθ_{f} is the numerical aperture of the first area 122. Let it be assumed that the angle of incidence θᵢ is the maximum half angle of view. of the first area 122. The plurality of microstructural bodies 120 are formed to give a maximum wave number component (i.e. a spatial-frequency component) K₁ to incident light as follows:

$${K}_{1} = {k}_{t} sin {θ}_{f} + {k}_{i} sin {θ}_{f} = \frac{2 π}{λ} n sin {θ}_{f} + \frac{2 π}{λ} n sin {θ}_{i} = \frac{2 π}{λ} NA + \frac{2 π}{λ} n sin {θ}_{i} \qquad ( 1 )$$

A minimum required sampling interval for giving the maximum wave number component K₁ in a unit cell, i.e. a pitch P between microstructural bodies 120, is determined according to the sampling theorem to satisfy Inequality (2) as follows:

$$\frac{2 π}{P} > 2 {K}_{1} \qquad ( 2 )$$

Accordingly, the pitch P between microstructural bodies 120 is determined to satisfy Inequality (3) as follows:

$$P < \frac{λ}{2 ( NA + n sin {θ}_{i} )} = \frac{λ}{2 ( n sin {θ}_{f} + n sin {θ}_{i} )} \qquad ( 3 )$$

By determining the position of each microstructural body 120 so as to satisfy this inequality, the sampling theorem can also be satisfied for light falling obliquely on the first area 122, so that it becomes easy to reproduce an ideal phase. This results in making it possible to prevent a reduction in aberration and a decrease in the efficiency of light collection.

Next, more preferred placement of microstructural bodies 120 is described with reference to FIGS. 8A to 8C.

FIG. 8A is a diagram schematically showing an example of an ideal phase profile in an unwrapped state. The horizontal axis represents coordinates r with the center of the first area 122 at the origin, and the vertical axis represents phase Φ. FIG. 8B is a diagram schematically showing an ideal phase profile wrapped in a range of phases of −π to π. FIG. 8C is a diagram schematically showing an example of sampling for achieving an ideal phase profile. In FIG. 8C, the black dots indicate examples of positions (i.e. sampling points) of microstructural bodies 120. As shown in these drawings, an adequate number of microstructural bodies 120 are placed in each of a plurality of sections wrapped in a range of −π to π. According to the sampling theorem, two or more microstructural bodies 120 are placed in one continuous section from −π to π.

In the example shown in FIGS. 8A to 8C, an area near the center of the first area 122 and an area near the end of the first area 122 differ in phase steepness from each other. The area near the center is higher in the rate of change in the phase Φ with respect to a change in the position r than the area near the end. In such a case, a pitch P2 between microstructural bodies 120 located near the end may be smaller than a pitch P1 between microstructural bodies 120 located near the center. Such placement of microstructural bodies 120 makes it possible to more accurately reproduce an ideal phase profile.

An increase in the number of microstructural bodies 120 included in one continuous section from −π to π, i.e. an increase in the number of samples, leads to further improvement in reproducibility of a phase profile. For example, placing three or more or four or more microstructural bodies 120 in each section makes it possible to further improve the reproducibility of a phase profile.

More detailed methods for designing a plurality of microstructural bodies 120 are disclosed in Japanese Patent Application No. 2022-058051 (filed on Mar. 31, 2022), Japanese Patent Application No. 2022-058052 (filed on Mar. 31, 2022), and Japanese Patent Application No. 2022-058053 (filed on Mar. 31, 2022), the entire contents of which are hereby incorporated by reference.

### Detailed Configuration of Meta-Lenses 100A to 100D

The following describes a detailed configuration of each of the meta-lenses 100A to 100D.

### First Meta-Lens 100A

In the first meta-lens 100A, the second area 124 functions as a convex lens having a second focal length. The second focal length has a positive value.

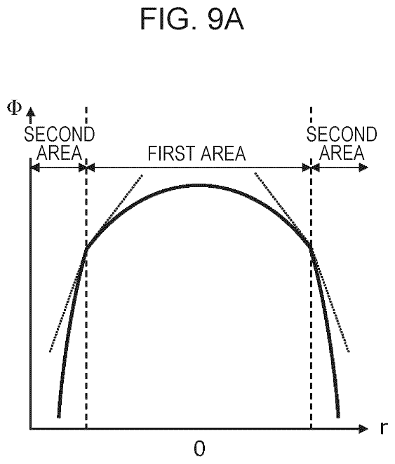

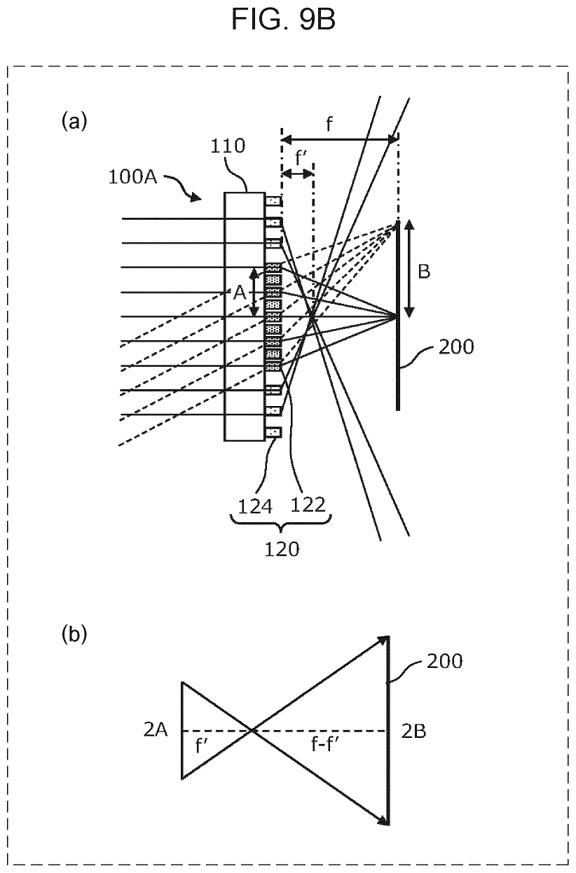

FIG. 9A is a diagram schematically showing an example of a phase profile of the first meta-lens 100A in an unwrapped state. As shown in FIG. 9A, the phase profile has a bent shape at a boundary between the first area 122 and the second area 124 and is indifferentiable at the boundary. A reason for this is that the first area 122 and the second area 124 have different properties. As shown in FIG. 9A, the phase monotonically decreases with distance from the origin regardless of whether it is in the first area 122 or the second area 124. The phase profile of the first meta-lens 100A in an unwrapped state has an upwardly convex shape. The phase profile has negative gradients in the first area 122 and the second area 124. The absolute value of the gradient in the phase profile at the inner end of the second area 124 is greater than the absolute value of the gradient in the phase profile at the end of the first area 122. In FIG. 9A, the dotted lines represent the gradients in the phase profile at the end of the first area 122 and the inner area of the second area 124.

That the phase profile is indifferentiable at the aforementioned boundary encompasses not only a case where the phase profile has a shape completely pointed at the aforementioned boundary but also a case where the phase profile has a shape slightly rounded at the aforementioned boundary. In actuality, depending on the accuracy of a manufacturing process and the accuracy of measurement, the phase profile can have a shape slightly rounded at the aforementioned boundary.

FIG. 9B is a diagram for explaining conditions that a first focal length and a second focal length satisfy in the first meta-lens 100A. Portion (a) of FIG. 9B is a ray trace diagram schematically showing a case where light falls on the first meta-lens 100A. In portion (a), the solid lines represent rays falling perpendicularly on the first area 122 and the second area 124, and the dashed lines represent rays falling on the first area 122 at a maximum half angle of view. Let it be assumed that the first focal length is f and that the second focal length is f′. f and f′ have positive values. Furthermore, let it be assumed that A is the distance from a position on a central axis in the first area 122 to an end of the first area 122 and that B is the distance from a position on the central axis on an image surface at the first focal length to a position of an image formed by light falling on the first area 122 at a maximum half angle of view. The distance B is equivalent to the distance from the center of the imaging area 200 to an end of the imaging area 200. The distance B is longer than the distance A. Portion (b) of FIG. 9B schematically shows how light falling on the inner end of the second area 124 is refracted inward and falls on the end of the imaging area 200.

The two triangles shown in portion (b) are in a similarity relationship with each other. For one of the triangles, 2A is the length of the base, and f′ is the height. For the other triangle, 2B is the length of the base, and f-f′ is the height. From the similarity relationship between the two triangles, f′:f-f′=A:B holds, whereby f′=[A/(A+B)]f is obtained. Accordingly, in a case were Formula (4) is satisfied as below, the light falling on the second area 124 and refracted inward passes outside the imaging area 200.

$${f}^{′} < \frac{A}{A + B} f \qquad ( 4 )$$

For all these reasons, even if the first meta-lens 100A has a second area 124 that does not have a desired lens function, the second area 124 does not cause deterioration in performance of the first meta-lens 100A, as long as Formula (4) is satisfied.

Although, in the example shown in portion (a), the second focal length of the second area 124 stays the same irrespective of distance from the center of the first area 122, this example is not intended to impose any limitation. The second focal length of the second area 124 may vary according to distance from the center of the first area 122. Such a second focal length of the second area 124 brings about improvement in degree of freedom of lens design. The second focal length f′ can, for example, become shorter with distance from the center of the first area 122. Even in a case where the second focal length f′ varies according to distance from the center of the first area 122, the second focal length f′ satisfies Formula (4).

As long as light refracted inward by the second area 124 passes outside the imaging area 200, the second area 124 does not need to function as a convex lens having a second focal length. That is, light refracted inward by the second area 124 does not need to pass through a particular point such as a focal point.

### Second Meta-Lens 100B

In the second meta-lens 100B, the second area 124 functions as a concave lens having a second focal length. The second focal length has a negative value.

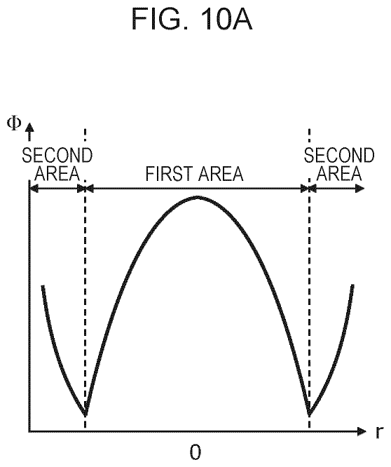

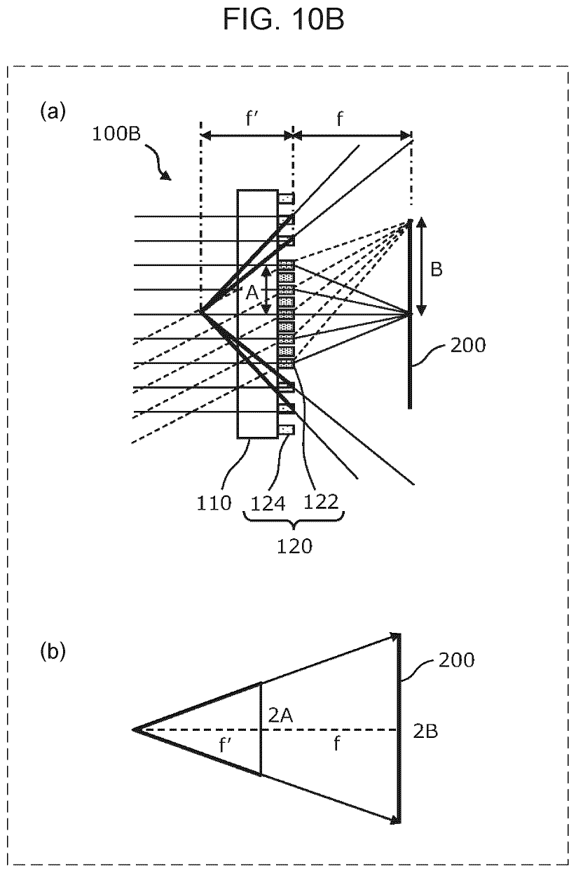

FIG. 10A is a diagram schematically showing an example of a phase profile of the second meta-lens 100B in an unwrapped state. As shown in FIG. 10A, the phase profile has a V shape at a boundary between the first area 122 and the second area 124 and is indifferentiable at the boundary. A reason for this is that the first area 122 and the second area 124 have different properties. As shown in FIG. 10A, the phase in the first area 122 monotonically decreases with distance from the origin, and the phase in the second area 124 monotonically increases with distance from the origin. The phase profile of the second meta-lens 100B in an unwrapped state in the first area 122 has an upwardly convex shape, and the phase profile of the second meta-lens 100B in an unwrapped state in the second area 124 has a downwardly convex shape. The phase profile has a negative gradient in the first area 122 and has a positive gradient in the second area 124.

FIG. 10B is a diagram for explaining conditions that a first focal length and a second focal length satisfy in the second meta-lens 100B. Portion (a) of FIG. 10B is a ray trace diagram schematically showing a case where light falls on the second meta-lens 100B. In portion (a), the oblique heavy lines indicate virtual rays obtained by extending, toward the side from which the light comes, rays falling on the second area 124 and refracted outward. In portion (a), the solid lines, the dashed lines, the distance A, and the distance B are as described with reference to FIG. 9B. Let it be assumed that the first focal length is f and that the second focal length is −f′. f and f′ have positive values. Portion (b) of FIG. 10B schematically shows how light falling on the inner end of the second area 124 is refracted outward and falls on the end of the imaging area 200.

The two triangles shown in portion (b) are in a similarity relationship with each other. For one of the triangles, 2A is the length of the base, and f′ is the height. For the other triangle, 2B is the length of the base, and f+f′ is the height. From the similarity relationship between the two triangles, f′:f+f′=A:B holds, whereby f′=[A/(B−A)]f is obtained. Accordingly, in a case were Formula (5) is satisfied as below, the light falling on the second area 124 and refracted outward passes outside the imaging area 200.

$${f}^{′} < \frac{A}{B - A} f \qquad ( 5 )$$

For all these reasons, even if the second meta-lens 100B has a second area 124 that does not have a desired lens function, the second area 124 does not cause deterioration in performance of the second meta-lens 100B, as long as Formula (5) is satisfied.

Although, in the example shown in portion (a), the second focal length of the second area 124 stays the same irrespective of distance from the center of the first area 122, this example is not intended to impose any limitation. The second focal length of the second area 124 may vary according to distance from the center of the first area 122. Such a second focal length of the second area 124 brings about improvement in degree of freedom of lens design. The absolute value f′ of the second focal length can, for example, become shorter with distance from the center of the first area 122. Even in a case where the absolute value f′ of the second focal length varies according to distance from the center of the first area 122, the absolute value f′ of the second focal length satisfies Formula (5).

As long as light refracted inward by the second area 124 passes outside the imaging area 200, the second area 124 does not need to function as a concave lens having a second focal length. That is, virtual rays obtained by extending, toward the side from which the light comes, rays refracted outward by the second area 124 do not need to pass through a particular point such as a focal point.

### Third Meta-Lens 100C

In the third meta-lens 100C, the second area 124 functions as a mirror that reflects incident light.

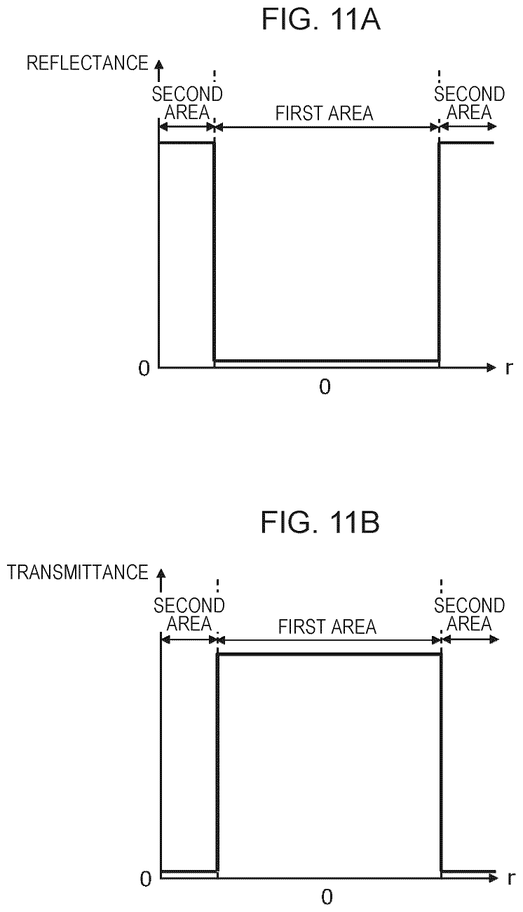

FIG. 11A is a diagram schematically showing an example of positional dependence of reflectance in the third meta-lens 100C. As shown in FIG. 11A, the second area 124 is sufficiently higher in reflectance than the first area 122. The higher the reflectance of the second area 124 is, the more effectively the second area 124 reflects the incident light. The reflectance of the first area 122 can be, for example, lower than or equal to 50%, lower than or equal to 30%, or lower than or equal to 10%. On the other hand, the reflectance of the second area 124 can be, for example, higher than or equal to 80% or higher than or equal to 90%.

FIG. 11B is a diagram schematically showing an example of positional dependence of transmittance in the third meta-lens 100C. As shown in FIG. 11B, the first area 122 is sufficiently higher in transmittance than the second area 124. The transmittance of the first area 122 can be, for example, higher than or equal to 50%. On the other hand, the transmittance of the second area 124 can be, for example, lower than or equal to 10% or lower than or equal to 5%.

In a case where the reflectance and transmittance of the second area 124 of the third meta-lens 100C have the aforementioned values, light falling on the second area 124 is effectively reflected and therefore hardly arrives at the imaging area 200.

For all these reasons, even if the third meta-lens 100C has a second area 124 that does not have a desired lens function, the second area 124 does not cause deterioration in performance of the third meta-lens 100C.

### Fourth Meta-Lens 100D

In the fourth meta-lens 100D, the second area 124 functions as an absorber that absorbs incident light.

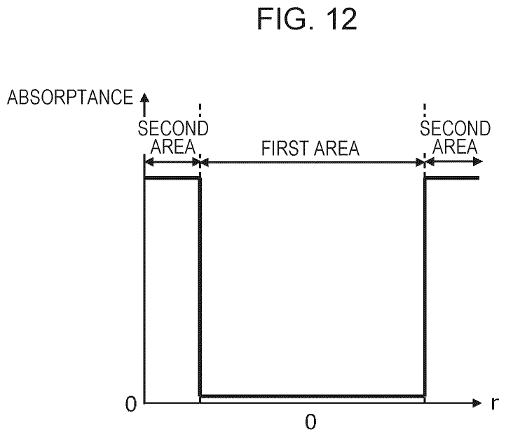

FIG. 12 is a diagram schematically showing an example of positional dependence of absorptance in the fourth meta-lens 100D. As shown in FIG. 12, the second area 124 is sufficiently higher in absorptance than the first area 122. The higher the absorptance of the second area 124 is, the more effectively the second area 124 can absorb the incident light. The absorptance of the first area 122 can be, for example, lower than or equal to 10% or lower than or equal to 5%. On the other hand, the absorptance of the second area 124 can be, for example, higher than or equal to 80% or higher than or equal to 90%.

The positional dependence of transmittance in the fourth meta-lens 100D is similar to the positional dependence of transmittance in the third meta-lens 100C. The first area 122 is sufficiently higher in transmittance than the second area 124. The transmittance of the first area 122 can be, for example, higher than or equal to 50%. On the other hand, the transmittance of the second area 124 can be, for example, lower than or equal to 10% or lower than or equal to 5%.

In a case where the reflectance and transmittance of the second area 124 of the fourth meta-lens 100D have the aforementioned values, light falling on the second area 124 is effectively absorbed and therefore hardly arrives at the imaging area 200.

For all these reasons, even if the fourth meta-lens 100D has a second area 124 that does not have a desired lens function, the second area 124 does not cause deterioration in performance of the fourth meta-lens 100D.

Furthermore, since the second area 124 absorbs incident light, generation of stray light can be reduced. Generation of stray light in the meta-lenses 100A to 100C may be reduced by placing, on an optical path of light refracted inward or outward or reflected by the second area 124, an absorber that absorbs the light.

### EXAMPLES

The following describes examples of the meta-lenses 100A to 100D. The following examples are results of a simulation. The wavelength of incident light in the simulation is λ=10 μm.

### First Meta-Lens 100A

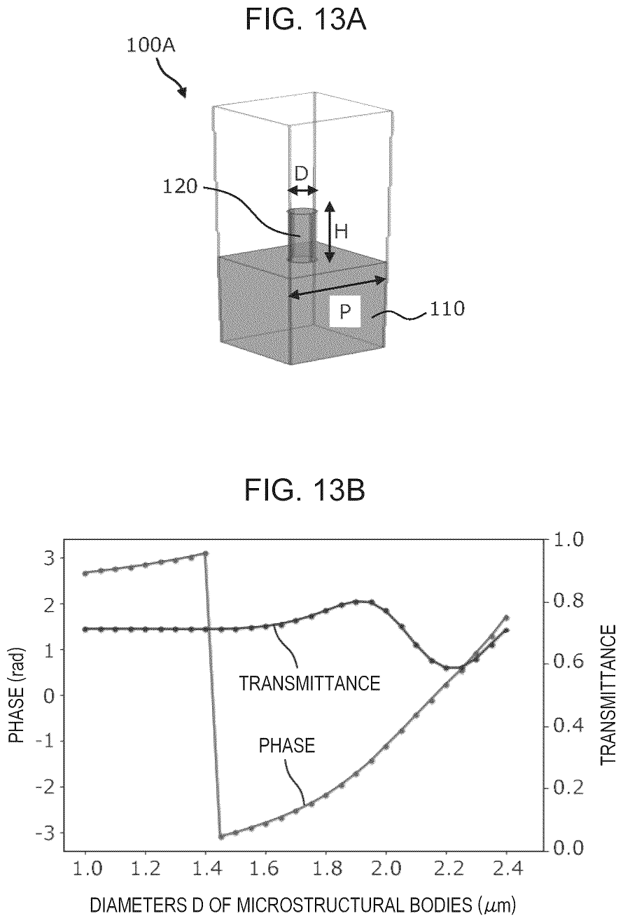

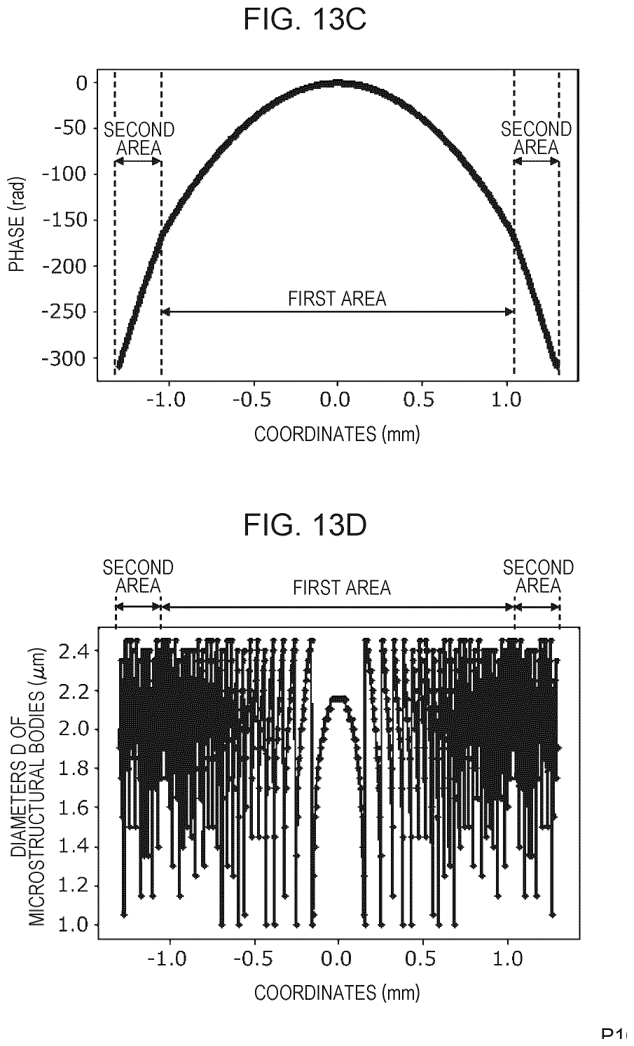

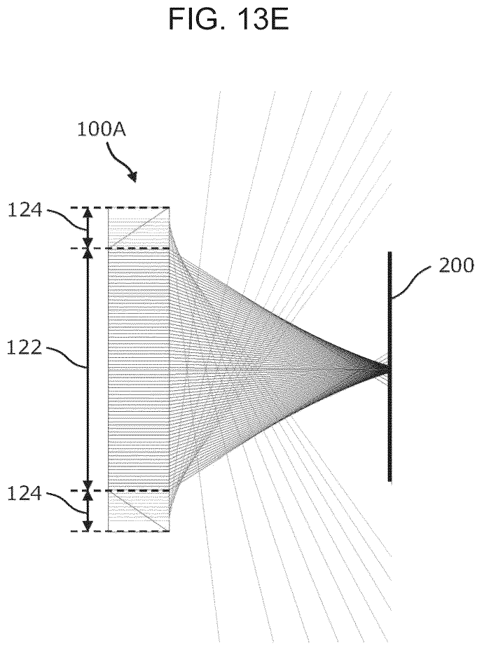

An example of the first meta-lens 100A is described with reference to FIGS. 13A to 13E. FIG. 13A is a diagram schematically showing a structure of a substrate 110 and each of the microstructural bodies 120 in the example of the first meta-lens 100A. The substrate 110 and the microstructural bodies 120 are made from an identical material. As the material, a material whose main component is silicon having a crystal plane orientation of (100) is used. The crystal plane orientation of silicon may be (110) or (111). Alternatively, a material that is different from silicon may be used.

The thickness of the substrate 110 is 500 μm. The shape of the substrate 110 is a regular square, and the size thereof is 2.6 mm×2.6 mm. On the surface 110s of the substrate 110 shown in FIG. 5, the first area 122 is a circular area having a diameter of 2.08 mm, and the second area 124 is a peripheral area therearound. The microstructural bodies 120 in the first area 122 and the second area 124 have diameters D of 1.0 μm to 2.4 μm, have a height H of 8.5 μm, and are placed at pitches P of 4.6 μm.

FIG. 13B is a graph showing a relationship between the diameters D of the microstructural bodies 120 and phase shift amount and a relationship between the diameters D of the microstructural bodies 120 and transmittance in the example of the first meta-lens 100A. The phase shift amount is displayed within the range of −π to π. The transmittance varies within a range of 0.58 to 0.8 with respect to the diameters D of 1.0 μm to 2.4 μm of the microstructural bodies 120.

FIG. 13C is a graph showing a phase profile of the example of the first meta-lens 100A in an unwrapped state. The vertical axis represents phase, and the horizontal axis represents coordinates. The coordinates have the center of the first area 122 at the origin. Let it be assumed that the phase at the origin is 0 (rad). As shown in FIG. 13C, the phase profile is bent at a boundary between the first area 122 and the second area 124 and is indifferentiable at the boundary. The phase monotonically decreases with distance from the origin regardless of whether it is in the first area 122 or the second area 124. The phase profile of the first meta-lens 100A in an unwrapped state has an upwardly convex shape. The phase profile has negative gradients in the first area 122 and the second area 124. The absolute value of the gradient in the phase profile at the inner end of the second area 124 is greater than the absolute value of the gradient in the phase profile at the end of the first area 122.

FIG. 13D is a graph showing a relationship between coordinates and the diameters D of the microstructural bodies 120 in the example of the first meta-lens 100A. The graph shown in FIG. 13D was made based on the relationship between the diameters D of the microstructural bodies 120 and phase shift amount shown in FIG. 13B in order to achieve the phase profile shown in FIG. 13C. In the first area 122 and the second area 124, the diameters D of the microstructural bodies 120 repeatedly increase and decrease in a range of 1.0 μm to 2.4 μm with distance from the origin. Cycles in which the diameters D increase and decrease become shorter with distance from the origin. In the first area 122 and the second area 124, the diameters D repeat, with distance from the origin, the behavior of increasing after having monotonically decreased so that the phase profile comes to have an upwardly convex shape.

Although the first area 122 and the second area 124 have different properties, they can be fabricated by the same fabrication process of placing microstructural bodies 120 having appropriately designed diameters D. This makes it easy to fabricate the first meta-lens 100A.

FIG. 13E is a ray trace diagram of a case where light falls perpendicularly on the example of the first meta-lens 100A. In FIG. 13E, the black and gray solid lines represent rays falling perpendicularly on the first area 122 and the second area 124, respectively.

As shown in FIG. 13E, the first area 122 functions as a convex lens and condenses perpendicularly incident light at the first focal length. The second area 124 functions as a convex lens and refracts perpendicularly incident light inward so that the light passes around the imaging area 200. In the example shown in FIG. 13E, the focal length of the first area 122 is 2 mm, the distance from the center of the first area 122 to the end of the first area 122 is 1.04 mm, and the distance from the center of the imaging area 200 to the end of the imaging area 200 is 1 mm. The focal length of the second area 124 satisfies Formula (4).

All these show that even if the first meta-lens 100A has a second area 124 that does not have a desired lens function, the second area 124 does not cause deterioration in performance of the first meta-lens 100A.

### Second Meta-Lens 100B

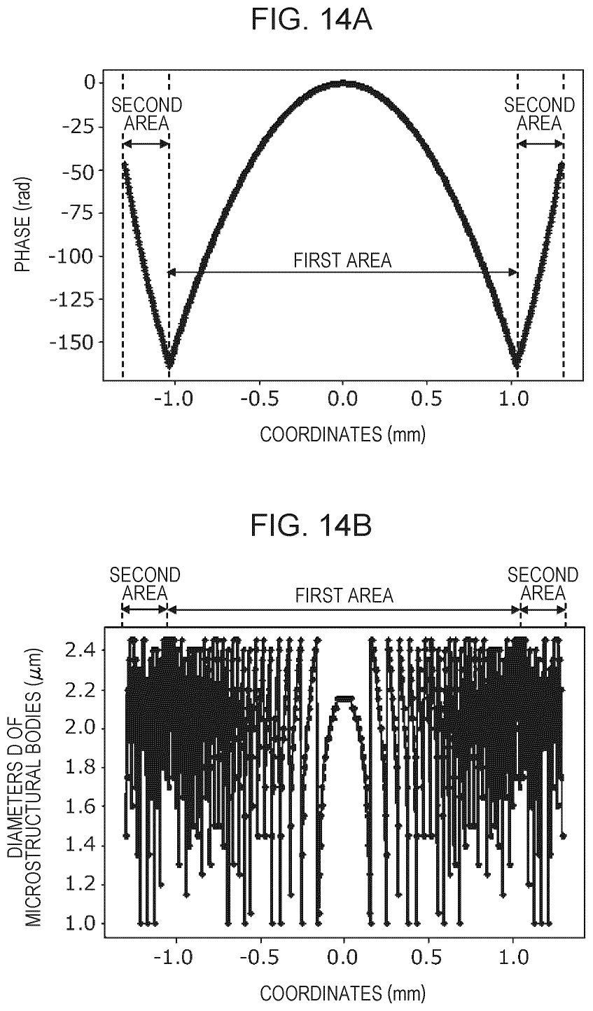

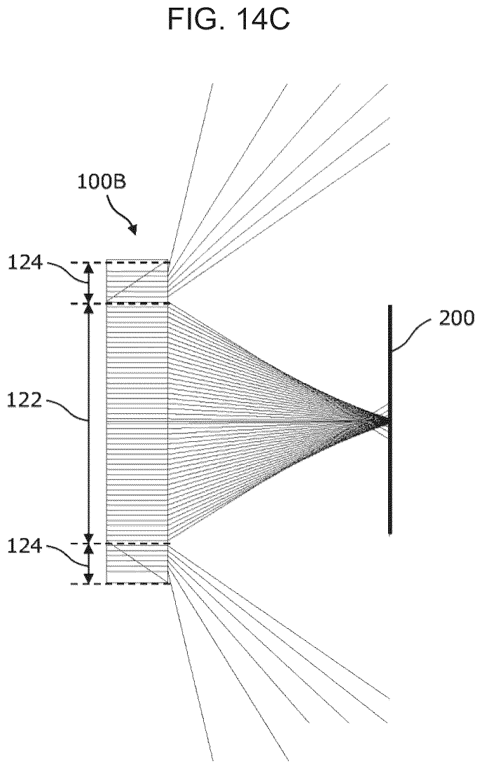

An example of the second meta-lens 100B is described with reference to FIGS. 14A to 14C. The diameter D, height H, and pitch P of each of the microstructural bodies 120 are as described with reference to FIG. 13A. The relationship between the diameters D of the microstructural bodies 120 and phase shift amount and the relationship between the diameters D of the microstructural bodies 120 and transmittance are as described with reference to FIG. 13B.

FIG. 14A is a graph showing a phase profile of the example of the second meta-lens 100B in an unwrapped state. As shown in FIG. 14A, the phase profile has a V shape at a boundary between the first area 122 and the second area 124 and is indifferentiable at the boundary. The phase in the first area 122 monotonically decreases with distance from the origin, and the phase in the second area 124 monotonically increases with distance from the origin. The phase profile of the example of the second meta-lens 100B in an unwrapped state in the first area 122 has an upwardly convex shape, and the phase profile of the example of the second meta-lens 100B in an unwrapped state in the second area 124 has a downwardly convex shape. The phase profile has a negative gradient in the first area 122 and has a positive gradient in the second area 124.

FIG. 14B is a graph showing a relationship between coordinates and the diameters D of the microstructural bodies 120 in the example of the second meta-lens 100B. The graph shown in FIG. 14B was made based on the relationship between the diameters D of the microstructural bodies 120 and phase shift amount shown in FIG. 13B in order to achieve the phase profile shown in FIG. 14A. In the first area 122 and the second area 124, the diameters D of the microstructural bodies 120 repeatedly increase and decrease in a range of 1.0 μm to 2.4 μm with distance from the origin. Cycles in which the diameters D increase and decrease become shorter with distance from the origin. In the first area 122, the diameters D repeat, with distance from the origin, the behavior of increasing after having monotonically decreased so that the phase profile comes to have an upwardly convex shape. In the second area 124, the diameters D repeat, with distance from the origin, the behavior of decreasing after having monotonically increased so that the phase profile comes to have a downwardly convex shape.

Although the first area 122 and the second area 124 have different properties, they can be fabricated by the same fabrication process of placing microstructural bodies 120 having appropriately designed diameters D. This makes it easy to fabricate the second meta-lens 100B.

FIG. 14C is a ray trace diagram of a case where light falls perpendicularly on the example of the second meta-lens 100B. As shown in FIG. 14C, the first area 122 functions as a convex lens and condenses perpendicularly incident light at the first focal length. The second area 124 functions as a concave lens and refracts perpendicularly incident light outward so that the light passes around the imaging area 200. In the example shown in FIG. 14C, the focal length of the first area 122 is 2 mm, the distance from the center of the first area 122 to the end of the first area 122 is 1.04 mm, and the distance from the center of the imaging area 200 to the end of the imaging area 200 is 1 mm. The absolute value of the focal length of the second area 124 satisfies Formula (5).

All these show that even if the second meta-lens 100B has a second area 124 that does not have a desired lens function, the second area 124 does not cause deterioration in performance of the second meta-lens 100B.

### Third Meta-Lens 100C

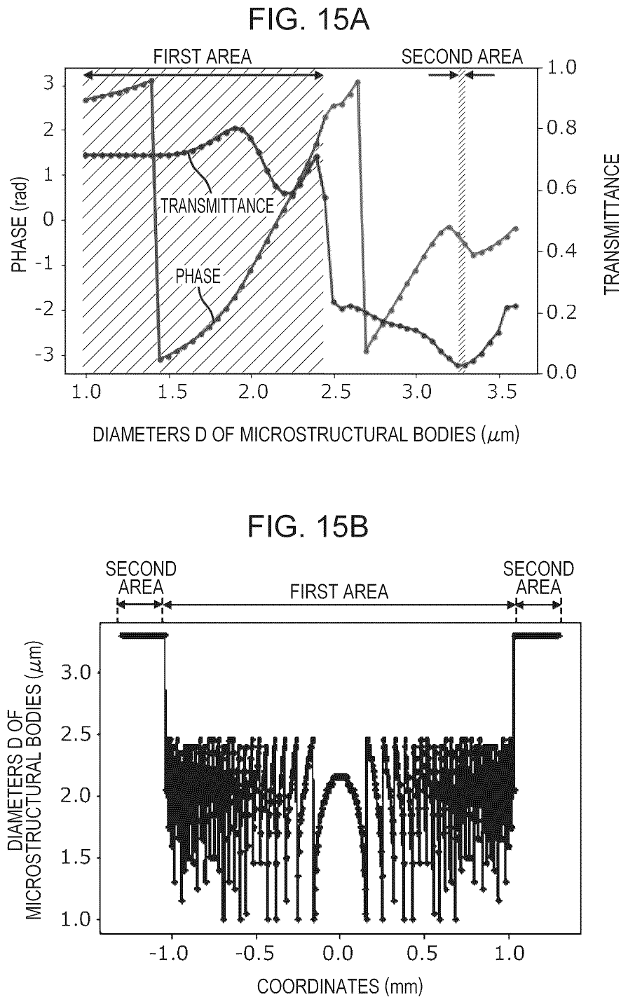

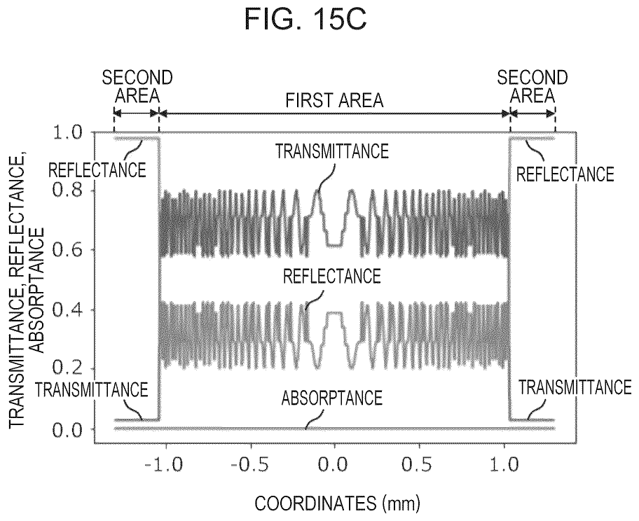

An example of the third meta-lens 100C is described with reference to FIGS. 15A to 15C.

FIG. 15A is a graph showing a relationship between the diameters D of the microstructural bodies 120 and phase shift amount and a relationship between the diameters D of the microstructural bodies 120 and transmittance in the example of the third meta-lens 100C. The dark gray area shown in FIG. 15A represents a range of diameters D of the microstructural bodies 120 in the first area 122. The light gray area shown in FIG. 15A represents a range of diameters D of the microstructural bodies 120 in the second area 124. The diameters D of the microstructural bodies 120 in the first area 122 range from 1.0 μm to 2.4 μm. The diameters D of the microstructural bodies 120 in the second area 124 range from 3.2 μm to 3.35 μm. The transmittance of the first area 122 varies within a range of 0.58 to 0.8. The transmittance of the second area 124 is lower than or equal to 0.045, and the reflectance of the second area 124 is higher than or equal to 0.95. The height H and pitch P of each of the microstructural bodies 120 in the first area 122 and the second area 124 are as described with reference to FIG. 13A.

FIG. 15B is a graph showing a relationship between coordinates and the diameters D of the microstructural bodies 120 in the example of the third meta-lens 100C. Of the graph shown in FIG. 15B, the relationship between coordinates and the diameters D of the microstructural bodies 120 in the first area 122 is as described with reference to FIG. 13D. Of the graph shown in FIG. 15B, the relationship between coordinates and the diameters D of the microstructural bodies 120 in the second area 124 was made based on the relationship between the diameters D of the microstructural bodies 120 and transmittance shown in FIG. 15A. As shown in FIG. 15B, the microstructural bodies 120 in the second area 124 have constant diameters D of 3.25 mm.

Although the first area 122 and the second area 124 have different properties, they can be fabricated by the same fabrication process of placing microstructural bodies 120 having appropriately designed diameters D. This makes it easy to fabricate the third meta-lens 100C.

FIG. 15C is a graph showing a relationship between coordinates and transmittance, a relationship between coordinates and reflectance, and a relationship between coordinates and absorptance in a case where light falls perpendicularly on the example of the third meta-lens 100C. As shown in FIG. 15C, the transmittance of the first area 122 varies within a range of 0.58 to 0.8, and the reflectance of the first area 122 varies within a range of 0.19 to 0.41. The reflectance of the second area 124 is higher than or equal to 0.95, and the transmittance of the second area 124 is lower than or equal to 0.026. The absorptance ranges approximately from 0.01 to 0.025 regardless of whether it is in the first area 122 or the second area 124.

As shown in FIG. 15C, the second area 124 is higher in reflectance than the first area 122. The second area 124 is lower in transmittance than the first area 122. Light falling on the second area 124 is effectively reflected and hardly arrives at the imaging area 200 shown in FIGS. 13E and 14C.

All these show that even if the third meta-lens 100C has a second area 124 that does not have a desired lens function, the second area 124 does not cause deterioration in performance of the third meta-lens 100C.

### Fourth Meta-Lens 100D

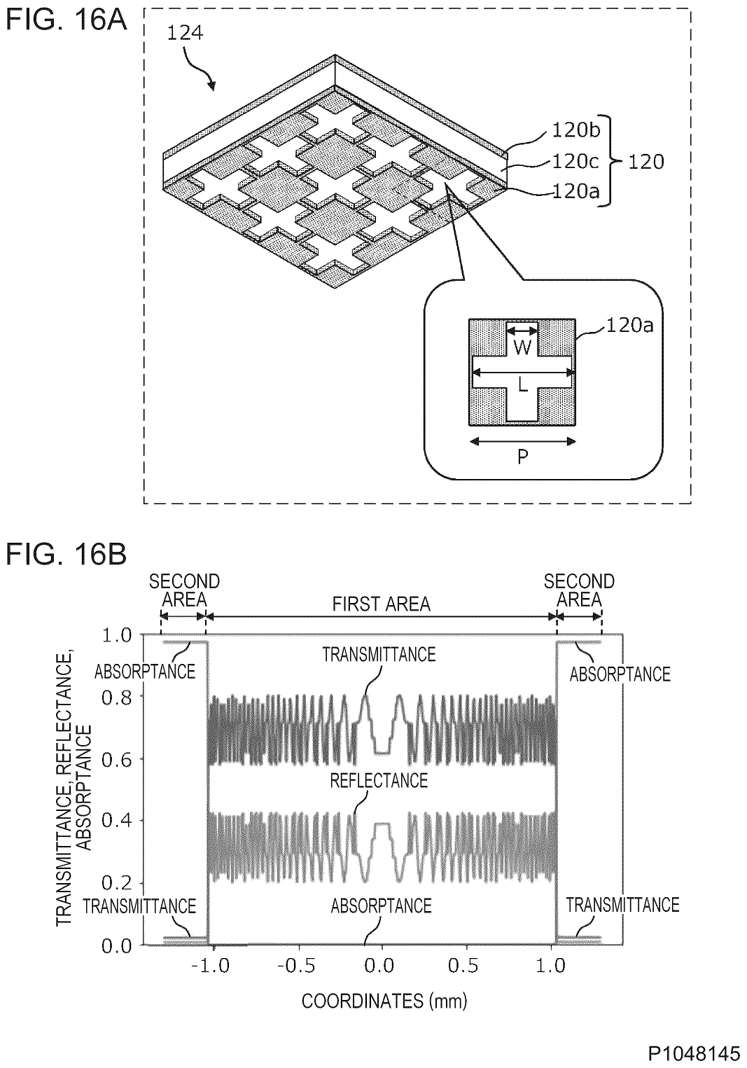

An example of the fourth meta-lens 100D is described with reference to FIGS. 16A and 16B. The diameter D, height H, and pitch P of each of the microstructural bodies 120 in the first area 122 are as described with reference to FIG. 13A. The relationship between coordinates and the diameters D of the microstructural bodies 120 in the first area 122 is as described with reference to FIG. 13D.

FIG. 16A is a perspective view schematically showing a structure of a second area 124 in the example of the fourth meta-lens 100D as seen from the substrate 110. The structure of the second area 124 is disclosed in J. Y. Jung et al., “Wavelength-selective infrared metasurface absorber for multispectral thermal detection”, IEEE Photon. J., vol. 7, no. 6, December 2015. As shown in FIG. 16A, the plurality of microstructural bodies 120 are two-dimensionally arranged. Each microstructural body 120 includes a first metal film 120a, a second metal film 120b, and a dielectric layer 120c sandwiched between the first metal film 120a and the second metal film 120b. As shown in the enlarged view, the first metal film 120a is provided with cruciform holes, and the second metal film 120b has a flat-plate shape. The first metal film 120a is part of a single metal film in which a plurality of cruciform holes are two-dimensionally provided. The second metal film 120b is part of a single metal film that spreads two-dimensionally. The dielectric layer 120c is part of a dielectric layer that spreads two-dimensionally.

The plurality of microstructural bodies 120 are arranged so that the first metal films 120a faces the substrate 110 shown in FIG. 5 at a spacing. A plurality of spacers for maintaining the spacing can be provided between the plurality of microstructural bodies 120 and the substrate 110. The plurality of spacers can be provided, for example, near inner and outer ends of an area of the surface 110s of the substrate 110 that overlaps the second area 124.

The cruciform holes in the first metal film 120a function as slot antennas and strongly resonate with light of a particular wavelength. As a result of that, light of a particular wavelength passing through the substrate 110 and falling on the second area 124 is strongly resonated by the first metal film 120a and then absorbed while being multiply reflected by the first metal film 120a and the second metal film 120b. Light of a particular wavelength is determined by the shape and size of the cruciform holes provided in the first metal film 120a.

According to J. Y. Jung et al., “Wavelength-selective infrared metasurface absorber for multispectral thermal detection”, IEEE Photon. J., vol. 7, no. 6, December 2015, the first metal film 120a and the second metal film 120b are formed from Ag. The thickness of the first metal film 120a is 50 nm. The thickness of the second metal film 120b is, for example, sufficiently as large as 150 nm. The pitch P of each of the cruciform holes is 2.0 μm. The length L of the longest portion of each of the cruciform holes is 1.45 μm. The length W of the shortest portion of each of the cruciform holes is 0.35 μm. The dielectric layer 120c is formed from Ge. The thickness of the dielectric layer 120c is 600 nm. Such a configuration makes it possible to absorb light of a wavelength of approximately 10 μm at a high absorptance of 95.83%.

FIG. 16B is a graph showing a relationship between coordinates and transmittance, a relationship between coordinates and reflectance, and a relationship between coordinates and absorptance in a case where light falls perpendicularly on the example of the fourth meta-lens 100D. The transmittance, reflectance, and absorptance of the first area 122 are as described with reference to FIG. 15C.

As shown in FIG. 16B, the absorptance of the second area 124 is higher than or equal to 0.95. The second area 124 is higher in absorptance than the first area 122. The second area 124 is lower in transmittance than the first area 122. Light falling on the second area 124 is effectively reflected and hardly arrives at the imaging area 200 shown in FIGS. 13E and 14C.

All these show that even if the fourth meta-lens 100D has a second area 124 that does not have a desired lens function, the second area 124 does not cause deterioration in performance of the fourth meta-lens 100D.

### Modifications

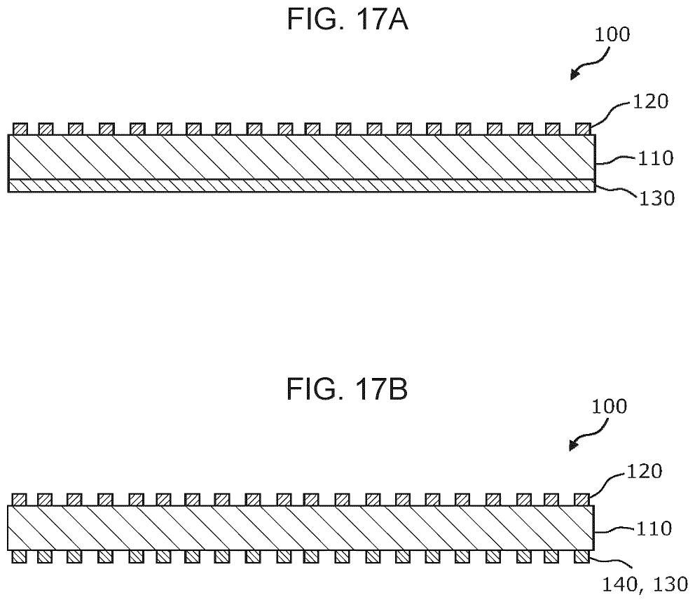

Modifications of the meta-lens 100 are described with reference to FIGS. 17A and 17B.

Although, in the foregoing embodiment, each microstructural body 120 is a convex body having a circular cylindrical shape, each microstructural body 120 may have a shape other than a circular cylinder. For example, each microstructural body 120 may be a columnar body having the shape of an elliptic cylinder or a polygonal column other than a circular cylinder. Alternatively, each microstructural body 120 may be a conical body having the shape of an elliptic cone (including a circular cone) or a polygonal cone. Furthermore, each microstructural body 120 is not limited to a convex body but may be a concave body. A concave body or a convex body constituting a microstructural body 120 can have any structure such as a columnar body having the shape of an elliptic cylinder or a polygonal column or a conical body having the shape of an elliptic cone or a polygonal cone.

Although, in the foregoing embodiment, the substrate 110 and each of the plurality of microstructural bodies 120 are made of an identical material, they may be made of different materials. For reduction of unwanted reflection or refraction between the substrate 110 and an array of the plurality of microstructural bodies 120, the difference between the refractive index of the substrate 110 and the refractive index of each of the plurality of microstructural bodies 120 may be, for example, lower than or equal to 10%, lower than or equal to 5%, or lower than or equal to 3% of the minimum refractive index of the refractive index of the substrate 110 and the refractive index of each of the plurality of microstructural bodies 120.

The substrate 110 and each of the plurality of microstructural bodies 120 may be made, for example, from a material whose main component is at least one selected from the group consisting of silicon, germanium, chalcogenide, chalcohalide, zinc sulfide, zinc selenide, fluoride compounds, thallium halide, sodium chloride, potassium chloride, potassium bromide, cesium iodide, and plastic (such as polyethylene). The term “main component” here refers to a component contained in the material in the highest proportion when expressed in mol percentage. In a case where the substrate 110 and each of the plurality of microstructural bodies 120 is made from the aforementioned material, the transmittance of infrared radiation ranging, for example, from 2.5 μm to 25 μm can be increased.

For improvement in transmittance, an AR (anti-reflection) function membrane may be additionally formed. Various light modulation layers having a light modulation function, as well as the AR function membrane, may be provided to the meta-lens 100.

FIG. 17A is a cross-sectional view schematically showing an example of a meta-lens 100 including a light modulation layer 130. The meta-lens 100 according to this example includes, on a surface of the substrate 110 that faces away from the surface at which the microstructural bodies 120 are provided, a light modulation layer 130 having a light modulation function. The light modulation layer 130 may have an anti-reflection function against incident light or may have another function. For example, the light modulation layer 130 may have the function of any of a high-pass filter, a low-pass filter, or a band-pass filter that transmits only light having a wavelength within the target wavelength range. Alternatively, the light modulation layer 130 may be a polarization filter having a function of transmitting only particular polarized light of incident light. Further, the light modulation layer 130 may be a filter having a function of attenuating or amplifying the transmission intensity of incident light having a wavelength within a particular wavelength range. The light modulation layer 130 may be an ND (neutral density) filter. The light modulation layer 130 may have a function of refracting incident light at a particular angle. The light modulation layer 130 can be constituted by a single layer or multiple layers according to a desired light modulation function. Further, the light modulation layer 130 can be made using a film-forming method such as a vacuum evaporation method or a sputtering method.

FIG. 17B is a cross-sectional view schematically showing an example of a meta-lens 100 in which a light modulation layer 130 includes a plurality of other microstructural bodies 140 that are different from the microstructural bodies 120. In this example, an array of microstructural bodies 120 is provided at one surface of the substrate 110, and an array of other microstructural bodies 140 is provided at an opposite surface of the substrate 110. Each of the other microstructural bodies 140 can be a convex body or a concave body. The convex body or the concave body can be, for example, a conical body having the shape of an elliptic cone or a polygonal cone or a columnar body having the shape of an elliptic cylinder or a polygonal column. The shape, size, and placement of the other microstructural bodies 140 may be different from the shape, size, and placement of the microstructural bodies 120. The other microstructural bodies 140 can be fabricated by a fabrication process that is similar to that by which each microstructural body 120 described in the foregoing examples is fabricated. Providing arrays of microstructural bodies (i.e. meta-surfaces) at both sides of the substrate 110 as in this example makes it easy to achieve a lens function that it is hard to achieve just by providing an array of microstructural bodies at one surface of the substrate 110.

### Conclusion

The foregoing description of embodiments discloses the following technologies.

### Technology 1

An optical lens that is used for light having a wavelength within a predetermined target wavelength range, the optical lens including:
a substrate having a surface; and
a plurality of microstructural bodies two-dimensionally provided at the surface of the substrate, wherein
the plurality of microstructural bodies include, on the surface of the substrate, a first area and a second area located outside the first area,
the first area has a property of condensing, at a predetermined focal length, first incident light incident on the first area, and
the second area has at least one selected from the group consisting of (a) a property of refracting inward second incident light incident on the second area, (b) a property of diffusing the second incident light, (c) a property of reflecting the second incident light, and (d) a property of absorbing the second incident light.

This optical lens makes it possible to reduce deterioration of performance even if there is an area that does not have a desired lens function.

### Technology 2

The optical lens according to technology 1, wherein
the predetermined focal length is a first focal length,
the second area functions as a convex lens having a second focal length, and
assuming that the first focal length is f and that the second focal length is f′, the following formula is satisfied:

$${f}^{′} < \frac{A}{A + B} f$$

where
A is a distance from a position on a central axis in the first area to an end of the first area, and
B is a distance from a position on the central axis on an image surface at the first focal length to a position of an image formed by light incident on the first area at a maximum half angle of view.

In this optical lens, light incident on the second area and refracted inward hardly arrives at the aforementioned imaging area.

### Technology 3

The optical lens according to technology 2, wherein the second focal length of the second area varies according to a distance from a center of the first area.

This optical lens brings about improvement in degree of freedom of lens design.

### Technology 4

The optical lens according to technology 1, wherein
the predetermined focal length is a first focal length,
the second area functions as a concave lens having a second focal length, and
assuming that the first focal length is f and that the second focal length is −f′, the following formula is satisfied:

$${f}^{′} < \frac{A}{B - A} f$$

where
A is a distance from a position on a central axis in the first area to an end of the first area, and
B is a distance from a position on the central axis on an image surface at the first focal length to a position of an image formed by light incident on the first area at a maximum half angle of view.

In this optical lens, light incident on the second area and diffused hardly arrives at the aforementioned imaging area.

### Technology 5

The optical lens according to technology 4, wherein the second focal length of the second area varies according to a distance from a center of the first area.

This optical lens brings about improvement in degree of freedom of lens design.

### Technology 6

The optical lens according to technology 1, wherein the second area is higher in reflectance than the first area.

This optical lens, in which the second area has a high reflectance, makes it possible to reduce the possibility that light incident on the second area may arrive at the aforementioned imaging area.

### Technology 7

The optical lens according to technology 1, wherein the second area is higher in absorptance than the first area.

This optical lens, in which the second area has a high absorptance, makes it possible to reduce the possibility that light incident on the second area may arrive at the aforementioned imaging area.

### Technology 8

The optical lens according to technology 1, 6, or 7, wherein the second area is lower in transmittance than the first area.

This optical lens, in which the second area has a low transmittance, makes it possible to reduce the possibility that light incident on the second area may arrive at the aforementioned imaging area.

### Technology 9

The optical lens according to any of technologies 1 to 5, wherein a phase profile of the optical lens in an unwrapped state is indifferentiable at a boundary between the first area and the second area.

This optical lens makes it possible to design the first and second areas so that the first and second areas have different properties.

### Technology 10

The optical lens according to any of technologies 1 to 8, wherein the first area and the second area differ from each other in at least one selected from the group consisting of a material of each of the plurality of microstructural bodies, a shape of each of the plurality of microstructural bodies, a size of each of the plurality of microstructural bodies, and a spacing between the plurality of microstructural bodies.

This optical lens makes it possible to design the first and second areas so that the first and second areas have different properties.

### Technology 11

The optical lens according to technology 1, wherein the second area has a property of refracting the second incident light inward.

### Technology 12

The optical lens according to technology 1, wherein
the predetermined focal length is a first focal length, and
the second area functions as a convex lens having a second focal length.

### Technology 13

The optical lens according to technology 1, wherein the second area has a property of diffusing the second incident light.

### Technology 14

The optical lens according to technology 1, wherein
the predetermined focal length is a first focal length, and
the second area functions as a concave lens having a second focal length.

### Technology 15

The optical lens according to technology 5, wherein
the plurality of microstructural bodies include a plurality of first microstructural bodies and a second microstructural body located in the first area and a plurality of third microstructural bodies and a fourth microstructural body located in the second area,
in the first area, an arrangement including the plurality of first microstructural bodies and the second microstructural body is repeated,
in the first area, a diameter of each of the plurality of first microstructural bodies monotonically decreases with an increase in distance from a center of the first area to each of the plurality of first microstructural bodies,
in the first area, the second microstructural body has a diameter having increased by a cumulative amount of monotonical decrease in diameters of the plurality of first microstructural bodies from a diameter that is smallest of the diameters of the plurality of first microstructural bodies,
in the second area, an arrangement including the plurality of third microstructural bodies and the fourth microstructural body is repeated,
in the second area, a diameter of each of the plurality of third microstructural bodies monotonically increases with an increase in distance from the center of the first area to each of the plurality of third microstructural bodies, and
in the second area, the fourth microstructural body has a diameter having decreased by a cumulative amount of monotonical increase in diameters of the plurality of third microstructural bodies from a diameter that is largest of the diameters of the plurality of third microstructural bodies.

An optical lens of the present disclosure is widely applicable to lens-equipped devices such as cameras, LiDAR sensors, projectors, AR displays, telescopes, microscopes, and optical scanners.

What is claimed is:

1. An optical lens that is used for light having a wavelength within a predetermined target wavelength range, the optical lens comprising:
a substrate having a surface; and
a plurality of microstructural bodies two-dimensionally provided at the surface of the substrate, wherein
the plurality of microstructural bodies include, on the surface of the substrate, a first area and a second area located outside the first area,
the first area has a property of condensing, at a predetermined focal length, first incident light incident on the first area, and
the second area has at least one selected from the group consisting of (a) a property of refracting inward second incident light incident on the second area, (b) a property of diffusing the second incident light, (c) a property of reflecting the second incident light, and (d) a property of absorbing the second incident light.

2. The optical lens according to claim 1, wherein
the predetermined focal length is a first focal length,
the second area functions as a convex lens having a second focal length, and
assuming that the first focal length is f and that the second focal length is f′, the following formula is satisfied:
$${f}^{′} < \frac{A}{A + B} f$$
where
A is a distance from a position on a central axis in the first area to an end of the first area, and
B is a distance from a position on the central axis on an image surface at the first focal length to a position of an image formed by light incident on the first area at a maximum half angle of view.

3. The optical lens according to claim 2, wherein the second focal length of the second area varies according to a distance from a center of the first area.

4. The optical lens according to claim 1, wherein
the predetermined focal length is a first focal length,
the second area functions as a concave lens having a second focal length, and
assuming that the first focal length is f and that the second focal length is −f′, the following formula is satisfied:
$${f}^{′} < \frac{A}{B - A} f$$
where
A is a distance from a position on a central axis in the first area to an end of the first area, and
B is a distance from a position on the central axis on an image surface at the first focal length to a position of an image formed by light incident on the first area at a maximum half angle of view.

5. The optical lens according to claim 4, wherein the second focal length of the second area varies according to a distance from a center of the first area.

6. The optical lens according to claim 1, wherein the second area is higher in reflectance than the first area.

7. The optical lens according to claim 1, wherein the second area is higher in absorptance than the first area.

8. The optical lens according to claim 1, wherein the second area is lower in transmittance than the first area.

9. The optical lens according to claim 1, wherein a phase profile of the optical lens in an unwrapped state is indifferentiable at a boundary between the first area and the second area.

10. The optical lens according to claim 1, wherein the first area and the second area differ from each other in at least one selected from the group consisting of a material of each of the plurality of microstructural bodies, a shape of each of the plurality of microstructural bodies, a size of each of the plurality of microstructural bodies, and a spacing between the plurality of microstructural bodies.

11. The optical lens according to claim 1, wherein the second area has a property of refracting the second incident light inward.

12. The optical lens according to claim 1, wherein
the predetermined focal length is a first focal length, and
the second area functions as a convex lens having a second focal length.

13. The optical lens according to claim 1, wherein the second area has a property of diffusing the second incident light.

14. The optical lens according to claim 1, wherein
the predetermined focal length is a first focal length, and
the second area functions as a concave lens having a second focal length.

15. The optical lens according to claim 5, wherein
the plurality of microstructural bodies include: a plurality of first microstructural bodies and a second microstructural body located in the first area; and a plurality of third microstructural bodies and a fourth microstructural body located in the second area,
in the first area, an arrangement including the plurality of first microstructural bodies and the second microstructural body is repeated,
in the first area, a diameter of each of the plurality of first microstructural bodies monotonically decreases with an increase in distance from a center of the first area to each of the plurality of first microstructural bodies,
in the first area, the second microstructural body has a diameter having increased by a cumulative amount of monotonical decrease in diameters of the plurality of first microstructural bodies from a diameter that is smallest of the diameters of the plurality of first microstructural bodies,
in the second area, an arrangement including the plurality of third microstructural bodies and the fourth microstructural body is repeated,
in the second area, a diameter of each of the plurality of third microstructural bodies monotonically increases with an increase in distance from the center of the first area to each of the plurality of third microstructural bodies, and
in the second area, the fourth microstructural body has a diameter having decreased by a cumulative amount of monotonical increase in diameters of the plurality of third microstructural bodies from a diameter that is largest of the diameters of the plurality of third microstructural bodies.
